(19) United States
(12) Patent Application Publication
(10) Pub. No.: US 2026/0091457 A1
(43) Pub. Date: Apr. 2, 2026

(54) Motorized Tool Changer Spindle

(71) Applicant: Beijing Zaowu Shidai Technology Co., Ltd., Beijing (CN)

(72) Inventors: Lishu GUO, Beijing (CN); Qiuxi Zhang, Beijing (CN); Wenchao Lan, Beijing (CN)

(21) Appl. No.: 18/901,855

(22) Filed: Sep. 30, 2024

(51) Int. Cl. B23Q 3/157; B23Q 5/04

(52) U.S. Cl. CPC B23Q 3/157; B23Q 5/04

(57) ABSTRACT

Disclosed is a motorized tool changer spindle comprising a spindle housing, a spindle shaft, a puller assembly slidable between a locking position and a tool-changing position under external force, a drive motor whose output shaft is drive-connected to a screw rod in threaded connection to a nut whose periphery is fixed with a limit component slidingly cooperating with a limit hole on the spindle housing. The nut can move under the action of the screw rod from an initial position at which the puller assembly is in the locking position to a termination position at which the puller assembly is in the tool-changing position. A position sensor sends signal to a controller upon detecting that the nut reaches the initial position and the controller stops the work of the drive motor. The disclosure simplifies structure, reduces operation noise, and facilitate miniaturization of tool changer spindle design.

### FIELD

The present invention generally relates to the field of miniature CNC machining equipment, and more particularly to a motorized tool changer spindle.

### BACKGROUND ART

This section provides background information related to the present disclosure which is not necessarily prior art.

At present, most of the motorized tool changer spindles used in miniature CNC machining equipment are pneumatic tool changers (such as an oil-mist lubricated high-speed ball spindle disclosed in Chinese patent application with Public No. CN115740519A), and the pneumatic tool changer system cylinder needs to be equipped with an air compressor to provide a gas source, while the air compressor needs to be realized through the air circuit with the air source between the air cylinder delivery, rendering high complexity of mating in the existing motorized tool changer spindles. The pneumatic tool changer system also features in big tool changing noise and poor safety. Moreover, the complexity of the air circuit makes it difficult to miniaturize the tool changer spindle.

### SUMMARY

This section provides a general summary of the disclosure, and is not a comprehensive disclosure of its full scope or all of its features.

[In view of the above drawbacks in the prior art, the present disclosure provides a motorized tool changer spindle with simplified structure, reduced noise and miniaturization.

To achieve the above objects, a motorized tool changer spindle according to the disclosure comprises a spindle housing, a spindle shaft rotatably mounted in the spindle housing and a puller assembly penetrating the spindle shaft, the puller assembly being slidable between a locked position and a tool-changing position along the axial direction of the spindle shaft under an external force, and a reset component between the puller assembly and the spindle shaft for driving the puller assembly from the tool-changing position to the locked position, the puller assembly comprising a tool holder located at the lowermost part and having tools on the inner periphery thereof. The motorized tool changer spindle further comprised a drive motor, the output shaft of which is connected to a screw rod, and a limit component is fixedly connected to the periphery of a nut in threaded connection with the screw rod, a limit hole adapted to the limit component is provided in the spindle housing, and the limit component is slidably cooperated with the limit hole in a vertical direction. The nut is movable in the vertical direction from an initial position to a termination position under the action of the drive motor and the screw rod, the puller assembly being in the locked position with the puller assembly in an anti-rotation fit with the spool when the nut is in the initial position, and the puller assembly being in the tool-changing position when the nut is in the termination position. A controller is provided to be electrically connected to a position sensor in the spindle housing and to the drive motor, the controller receiving a signal from the position sensor upon detecting that the nut reaches the initial position and controlling the drive motor to stop working.

The motorized tool changer spindle of the present disclosure replaces the traditional pneumatic drive way with a motor drive way, which simplifies the overall structure, reduces the operation noise, and facilitates the miniaturization of the tool changer spindle design. The drive motor drives the nut up or down through the screw rod, thus realizing switching of the puller assembly between the locking position and the tool changing position. In addition, the limit component fixedly mounted on the outer periphery of the nut, by cooperating with the limit hole, can play a role in limiting the degree of freedom of rotation of the nut, and can also play a role in limiting the displacement of the nut. Furthermore, the position sensor can make the nut stop precisely at a constant initial position when traveling upward, thereby eliminating the displacement error accumulated by the drive motor after running for a long time.

The top of the puller assembly may be higher than the top of the spindle shaft when the puller assembly is in the locked position, and the top of the puller assembly may be higher than or flush with the top of the spindle shaft when the puller assembly is in the tool changing position. This prevents the nut from contacting the spindle shaft within its travel range, reducing resistance during operation of the nut and lowering the requirement on accuracy of alignment between the nut and the puller assembly, which is conducive to reducing costs and increasing the reliability of system operation.

A transmission portion may be provided at the top periphery of the spindle shaft, and an opening may be provided in the spindle housing corresponding to the position of the transmission portion. The transmission portion is connected to an external drive mechanism through the opening, and the drive mechanism applies a torque to the spindle shaft through the transmission portion. In this connection structure, the transmission portion is located on the outside of the spindle housing, so that the drive mechanism can be externally mounted, which further simplifies the structure of the tool changer spindle and facilitate miniaturization.

A first conical surface with a small top and a large bottom may be provided at the bottom of the inner periphery of the spindle shaft, and a second conical surface may be provided at the outer periphery of the tool holder to cooperate with the first conical surface, so that when the puller assembly is located in the locked position thereof, the first conical surface and the second conical surface butt against each other to cause an anti-rotation fit between the puller assembly and the spindle shaft.

A plurality of notches may be provided on the tool holder through the bottom thereof, a mounting half-slot may be provided on the lower portions of each two opposite sides of the notches, and two mounting half-slots of the same notch may enclose to form a mounting groove, in which a resilient member may be embedded. When the puller assembly is in its locked position, the mounting groove is located inside the spindle shaft and the tool holder clamps the tool. When the puller assembly is in its tool changing position, the mounting groove extends below the spindle shaft, with a gap between the inner periphery of the tool holder and the outer periphery of the tool.

When the puller assembly is in the locked position, the first conical surface exerts a locking binding force on the tool holder, causing the notch of the tool holder to tend to close; when the puller assembly is moved downward, the second conical surface gradually moves away from the first conical surface. In this process, the tool holder is gradually released from the binding force of the first conical surface of the spindle shaft, causing the notch of the tool holder to gradually reset to open.

In order to prevent the tool holder from being difficult to reset after a long period of use, the present application has an elastic member embedded in the mounting groove for applying an elastic force to the two opposite sides of the notch when the puller assembly is in the tool changing position, so that the notch is reset smoothly to open, and the tool holder can release the tool that is clamped at the inner periphery thereof.

The mounting half-slots may be set through in the direction of the wall thickness of the tool holder.

The puller assembly may include a pull rod slidingly cooperating with the spindle shaft, a reset component being provided between the pull rod and the spool. A bottom portion of the pull rod is threaded to a top portion of the tool holder. The threaded connection of the tool holder and the pull rod facilitates a simpler tool change process without removing the tool holder when replacing a tool with another one of similar model. In addition, if a tool of significant model difference is to be changed, the tool holder can be loosened and removed from the bottom of the pull rod to replace the tool holder with one that is compatible with the tool.

The outer periphery of the pull rod and the inner periphery of the spindle shaft may have a gap therebetween to reduce friction between the pull rod and the spindle shaft.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

To more clearly illustrate the technical solutions in the specific embodiments or prior art of the present disclosure, the accompanying drawings used in the description of the specific embodiments or prior art will be briefly described below. Among all the accompanying drawings, similar elements or portions are generally identified by similar reference signs, and the elements or portions are not necessarily drawn to actual scale.

FIG. 1 is a schematic view showing the structure of a motorized tool changer spindle of an embodiment of the present disclosure;

FIG. 2 is an exploded view of a motorized tool changer spindle of an embodiment of the present disclosure;

FIG. 3 is a partial sectional view of a motorized tool changer spindle of an embodiment of the present disclosure; and

FIG. 4 is a schematic diagram of the structure of a tool holder of an embodiment of the present disclosure.

### REFERENCE SIGNS:

1: spindle housing 11: upper housing 111: opening 112: limit hole

12: lower housing 2: drive motor 20: puller assembly

3: spindle shaft 31: transmission portion 32: first conical surface

4: pull rod 41: reset component

5: tool holder 51: second conical surface

52: notch 521: mounting groove

6: tool 7: screw rod

8: nut 81: limit component 9: position sensor

Corresponding reference numerals indicate corresponding parts throughout the several views of the drawings.

### DETAILED DESCRIPTION

Example embodiments will now be described more fully with reference to the accompanying drawings.

Embodiments of the present disclosure will be described in detail in connection with the accompanying drawings, which are only used to illustrate the technical solution of the present disclosure more clearly, and therefore are only for exemplary purpose rather than limiting the scope of protection.

It is to be noted that unless otherwise indicated, terms used in this disclosure should be given their ordinary meaning as understood by those skilled in the art.

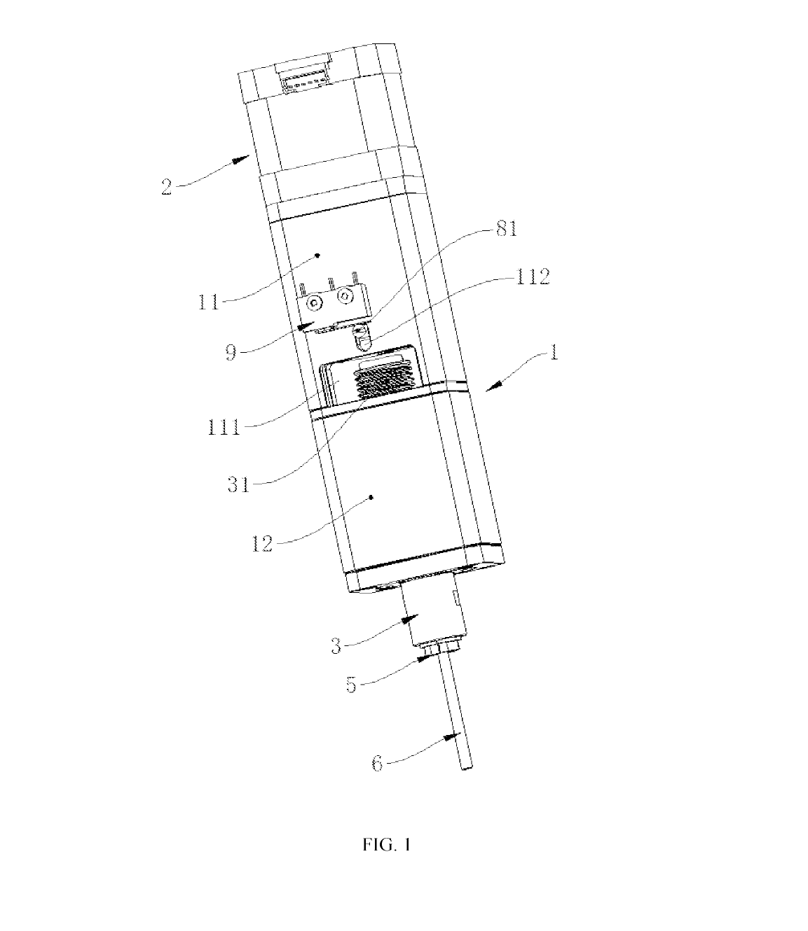

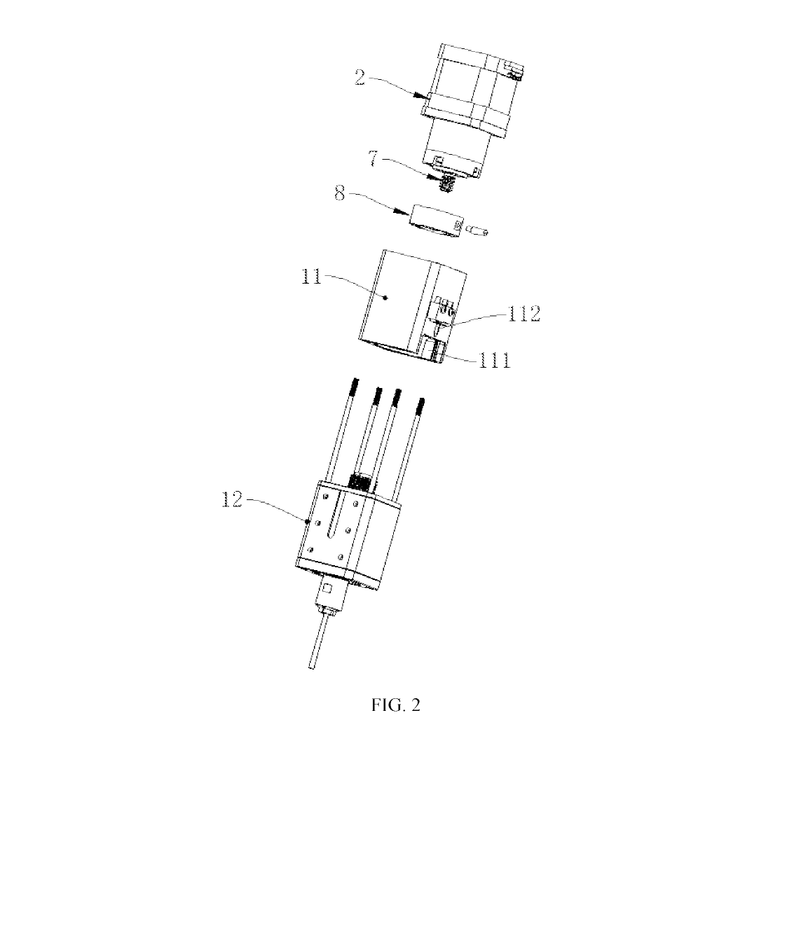

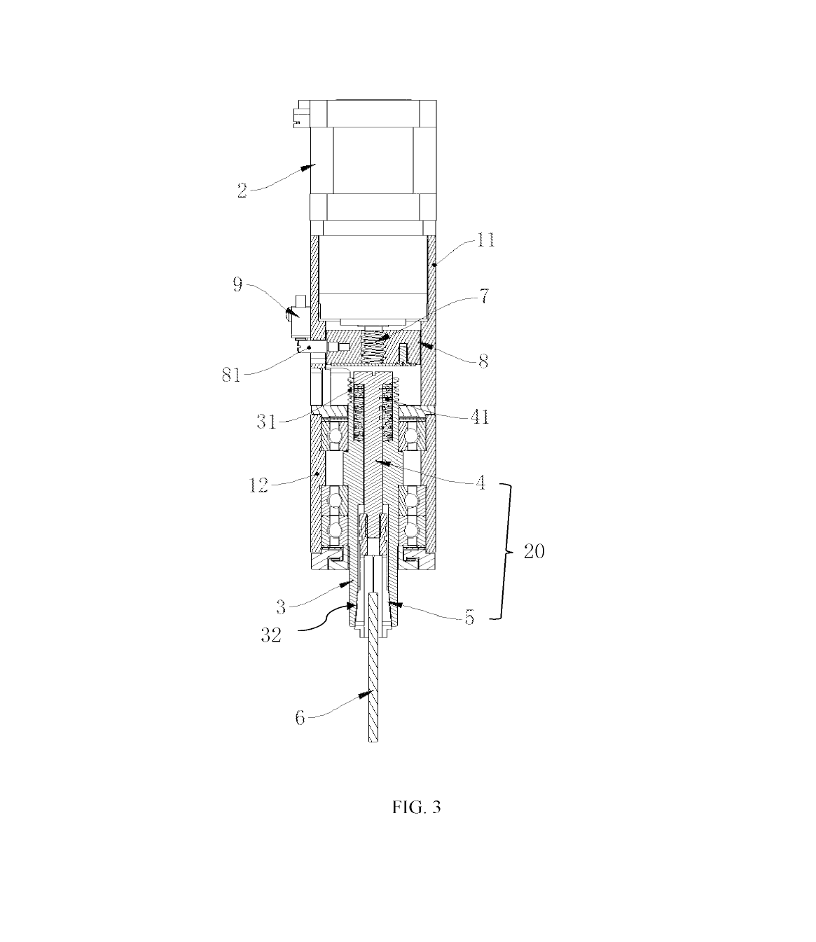

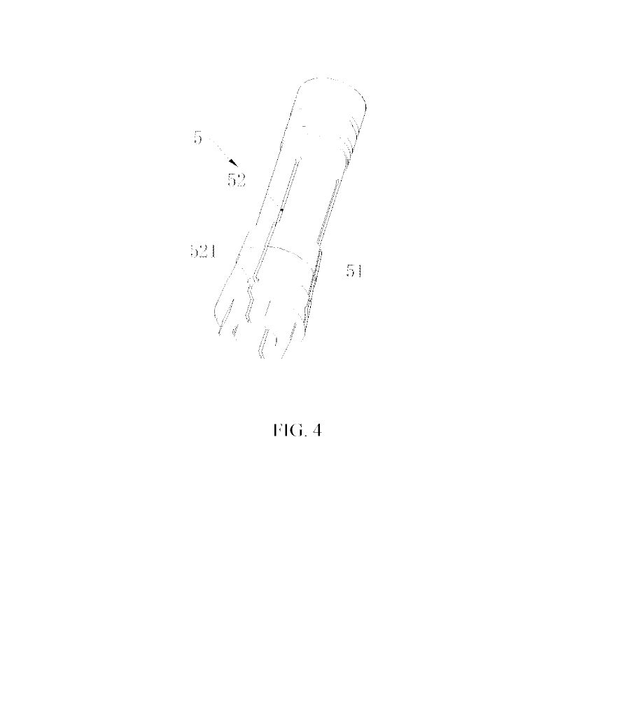

Referring to FIG. 1-FIG. 4, an embodiment of the present disclosure provides a motorized tool changer spindle having a spindle housing 1. The spindle housing 1 includes an upper housing 11 and a lower housing 12. A drive motor 2 which may be a servomotor is provided at the top of the upper housing 11. The drive motor 2, the upper housing 11 and the lower housing 12 are connected in turn by four bolts.

A spindle shaft 3 is mounted and being rotatable in the direction of its own axis within the lower housing 12. Bearings are provided between the outer periphery of the spindle shaft 3 and the inner periphery of the lower housing 12 to enable smooth rotation of the spindle shaft 3 relative to the lower housing 12. A top end of the spindle shaft 3 extends out of the top of the lower housing 12. A transmission portion 31 is provided at the top periphery of the spindle shaft 3. The transmission portion 31 can be connected to an external drive mechanism by a belt. The external drive mechanism applies a torque to the spindle shaft 3 through the transmission portion 31 to enable the spindle shaft 3 to rotate relative to the spindle housing 1. Accordingly, an opening 111 is provided in one of the side walls of the upper housing 11 corresponding to the drive section 31. The opening 111 facilitates extending of the belt into the upper housing 11 to connect with the drive section 31. In some embodiments, the transmission section 31 may also be designed to be driven in conjunction with a gear or a chain.

A puller assembly 20 is set inside the spindle shaft 3 and is capable of sliding between a locking position and a tool changing position along the axial direction of the spindle shaft 3 under an external force. The puller assembly 20 includes a pull rod 4 and a tool holder 5 arranged in a top and bottom arrangement. the bottom of the pull rod 4 is in threaded connection with the top of the tool holder 5, and a tool 6 is set inside the tool holder 5.

A first conical surface 32 with a small top and a large bottom is provided at the bottom of the inner periphery of the spindle shaft 3. The outer periphery of the tool holder 5 is provided with a second conical surface 51 that cooperates with the first conical surface 32, so that when the puller assembly 20 is in its locked position, the first conical surface 32 and the second conical surface 51 are pressed against each other to make a anti-rotation fit between the puller assembly 20 and the spindle shaft 3. The offset of the first conical surface 32 and the second conical surface 51 has a wedging effect so that the tool holder 5 and the spindle shaft 3 cannot rotate relative to each other, thereby synchronizing the rotation of the tool 6.

The tool holder 5 is provided with a plurality of notches 52 cutting through the bottom thereof, disposed equally around the axis circle of the tool holder 5. Mounting half-slots are provided in the lower portions of opposite sides of each notch 52, and two mounting half-slots of the same notch 52 enclose to form a mounting slot 521. A cylindrical resilient member (not shown in the drawings) is embedded in the mounting slot 521. When the puller assembly 20 is in its locked position, the mounting slot 521 is located inside the spindle shaft 3. The first conical surface 32 of the spindle shaft 3 exerts a locking constraint on the tool holder 5 such that the notch 52 of the tool holder 5 tends to close to reduce the inner peripheral dimensions of the tool holder 5, thereby locking the tool 6 to prevent it from falling out.

The resilient member within the mounting slot 521 will be compressed to store force during tightening of the notch 52. The second conical surface 51 of the tool holder 5 will gradually move away from the first conical surface 32 of the spindle shaft 3 as the puller assembly 20 is moving downwardly towards its tool changing position by an external force. In the process, the tool holder 5 will gradually be released from the binding force of the first conical surface 32 of the spindle shaft 3, causing the notch 52 of the tool holder 5 to gradually reset and open. The resetting and opening of the notch 52 increase the size of the inner periphery of the tool holder 5, which in turn causes a gap between the inner periphery of the tool holder 5 and the outer periphery of the tool 6, thereby releasing the tool 6 to facilitate the tool replacement.

In order to prevent the tool holder 5 from having a situation in which the notch 52 is difficult to open after a long period of use, an elastic member is embedded in the mounting groove 521, which can gradually apply an elastic force to the two opposing surfaces of the gap 52 in the downward movement of the puller assembly 20, so that the gap 52 is smoothly reset and opened, thereby causing the tool holder 5 to release the tool 6 which is clamped to the inner periphery thereof, and in the case that the puller assembly 20 is located in the tool changing position, the mounting groove 521 extends beyond the spindle shaft 3.

The output shaft of the drive motor 2 is in drive connection with a screw rod 7 which is in threaded connection with the nut 8. A limit component 81 is fixedly connected to the outer periphery of the nut 8. A threaded hole is formed at the outer periphery of the nut 8 in its radial direction. The limit component 81 is in threaded connection with the nut 8. A limit hole 112 adapted to the limit component 81 is provided in the upper housing 11. The limit hole 112 is a bar-shaped hole slidingly fitted with the limit component 81 in the vertical direction. The nut 8 can move from an initial position to a termination position in the vertical direction under the action of the drive motor 2 and the screw rod 7. When the nut 8 is in the initial position, the puller assembly 20 is in the locked position. At this time, the puller assembly 20 and the spindle shaft 3 are in an anti-rotation fit, so that the puller assembly 20 can rotate in synchronization with the spindle shaft 3, which facilitates driving the tool 6 to rotate and work. When the nut 8 is in the terminated position, the puller assembly 20 is in the tool changing position. At this point, the tool holder 5 releases the tool 6 to facilitate replacement.

The tool holder 5 of this embodiment has a plurality of models, each of which can be matched to a tool 6 within a corresponding size range. In the event that the size of the tool 6 to be replaced does not match the model of the tool holder 5 in use, the tool holder 5 can be loosened by rotating the tool holder 5 when the puller assembly 20 is in the tool changing position in order to change to the matching model of the tool holder 5, and then install the desired tool 6.

Further, the top of the pull rod 4 is above the top of the spindle shaft 3 when the puller assembly 20 is in its locked position. With the puller assembly 20 in the tool changing position, the top of the pull rod 4 is above or flush with the top of the spindle shaft 3, and there is a gap between the outer periphery of the pull rod 4 and the inner periphery of the spindle shaft 3.

In addition, a reset component 41, for example a plurality of stacked disc springs socketed on the periphery of the pull rod 4, is provided between the pull rod 4 and the spindle shaft 3. This reset component 41 is used to move the puller assembly 20 from the tool changing position to the locked position after external force is released.

The electric tool changer spindle of this application abandons the traditional pneumatic drive way and instead uses the drive motor 2 for driving, which simplifies the overall structure, reduces operation noise, and facilitates the miniaturization of the tool changer spindle.

Specifically, the drive motor 2 drives the nut 8 down through the screw rod 7 till the bottom of the nut 8 contacts the top of the pull rod 4, then the puller assembly 20 is driven from the locked position to the tool changing position as the nut 8 continues to descend. After the tool changer is completed, the drive motor 2 drives the nut 8 upward. At this time, the pressure exerted on the top of the pull rod 4 is released. The pull rod 4 will be reset by the elastic force of the reset component 41 to realize the locking of the tool 6.

Further, a position sensor 9 is mounted on the outer side of the upper housing 11 and located above the limit hole 112. The position sensor 9 is, for example, a microswitch whose movable arm is located on the movement path of the limit component 81.

The motorized tool changer spindle of this embodiment also includes a controller (not shown in the drawings) electrically connected to the position sensor 9 and the drive motor 2. During the upward movement of the nut 8 from the termination position to the initial position, the limit component 81 slides upwardly in the limit hole 112. When the limit component 81 contacts the movable arm of the microswitch, the position sensor 9 is triggered to send a feedback signal to the controller which then controls the drive motor 2 to stop working accordingly, and in turn causes the nut 8 to stop moving. By providing the position sensor 9, the nut 8 can be controlled to stop precisely at a constant initial position when traveling upward, so as to eliminate the displacement error accumulated by the drive motor 2 after running for a long time.

It is to be noted that in practice, it is necessary to determine the working time of the driving motor 2 based on the linear displacement of the nut 8 in a unit time and the distance between the puller assembly 20 in its locking position and the tool changing position, and then to control the starting and stopping of the driving motor 2 by the controller, so that the nut 8 can be accurately stopped at the termination position, preventing the nut 8 from colliding with the top of the spindle shaft 3. With the position sensor 9, when the nut 8 is moving upward, it is not necessary to determine whether the nut 8 stops moving according to the working time of the drive motor 2, while ensuring the nut 8 to stay in the same initial position every time.

While various specific details are described above, it can be appreciated that embodiments of the present disclosure may be practiced without repeating these specific details in full. In some examples, methods, systems and techniques that are known in the art are not shown in detail to avoid causing confusion in understanding the invention contained in this disclosure.

In the description of this specification, terms like "an embodiment" , "some embodiments", "examples", "specific examples", or "some examples" are intended to mean that the specific features, systems, materials, or characteristics described in conjunction with that embodiment or example are included in at least one embodiment or example of the present disclosure.. In this disclosure, schematic expressions of these terms may not direct to the same embodiment or example. Moreover, the specific features, systems, materials, or characteristics described may be combined in any one or more embodiments or examples in a suitable manner. Moreover, those skilled in the art may combine and combine different embodiments or examples and features of different embodiments or examples described in this specification without contradicting each other.

Finally, it should be noted that the above embodiments are only for illustrating the technical solution of the present disclosure but not intended to be interpreted as a limitation. Although the present disclosure has been described in detail with reference to the foregoing embodiments, a person of ordinary skill in the art should understand that the technical solutions recorded in the foregoing embodiments may be modified, or some or all the technical features therein may be replaced with equivalent ones. These modifications or substitutions do not take the essence of the corresponding technical solutions out of the scope of the technical solutions of the embodiments of the present disclosure and should fall within the scope of the claims and specification of the present application.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A motorized tool changer spindle comprising a spindle housing, a spindle shaft rotatably mounted in the spindle housing and a puller assembly penetrating the spindle shaft, the puller assembly being slidable between a locked position and a tool-changing position along the axial direction of the spindle shaft under an external force, and a reset component between the puller assembly and the spindle shaft for driving the puller assembly from the tool-changing position to the locked position , the puller assembly comprising a tool holder located at the lowermost part and having tools on the inner periphery thereof, wherein,
a drive motor is provided, the output shaft of which is connected to a screw rod, and a limit component is fixedly connected to the periphery of a nut in threaded connection to the screw rod, a limit hole adapted to the limit component is provided in the spindle housing, and the limit component is slidingly cooperated with the limit hole in a vertical direction;
the nut is movable in the vertical direction from an initial position to a termination position under the action of the drive motor and the screw rod, the puller assembly being in the locked position with the puller assembly in a anti-rotation mating fit with the spool when the nut is in the initial position, and the puller assembly being in the tool-changing position when the nut is in the termination position; and
a controller is provided to be electrically connected to a position sensor in the spindle housing and to the drive motor, the controller receiving a signal from the position sensor upon detecting that the nut reaches the initial position and controlling the drive motor to stop working.

2. The motorized tool changer spindle according to claim 1, wherein,
the top of the puller assembly is higher than the top of the shaft when the puller assembly is in the locked position, and the top of the puller assembly is higher than or flush with the top of the shaft when the puller assembly is in the tool changing position.

3. The motorized tool changer spindle according to claim 1, wherein
a transmission portion is provided at the top periphery of the spindle shaft, and an opening is provided in the spindle housing corresponding to the transmission portion, the transmission portion being connected to a drive mechanism through the opening, and the drive mechanism applying a torque to the spindle shaft by means of the transmission portion.

4. The motorized tool changer spindle according to claim 1, wherein
the shaft is provided with a first conical surface at the bottom of the inner periphery of the shaft, the tool holder is provided with a second conical surface at the outer periphery of the tool holder which cooperates with the first conical surface, the first conical surface and the second conical surface being in contact with each other when the puller assembly is located in the locked position to cause a anti-rotation fit between the puller assembly and the spindle shaft.

5. The motorized tool changer spindle according to claim 1, wherein
the tool holder is provided with a plurality of notches cutting through the bottom thereof, the notches are provided with mounting half-slots on the lower portions of opposite sides of the notches, and two of the mounting half-slots of the same notch enclose to form a mounting groove in which a resilient member is embedded; and
when the puller assembly is in the locked position, the mounting groove is disposed within the spindle shaft and the tool holder clamps the tool, and when the puller assembly in the tool-changing position, the mounting groove extends below the spindle shaft and there is a gap between the inner periphery of the tool holder and the outer periphery of the tool.

6. The motorized tool changer spindle according to claim 1, wherein
the mounting half-slots are provided through the wall thickness direction of the tool holder.

7. The motorized tool changer spindle according to claim 1, wherein
the puller assembly comprises a pull rod slidingly cooperating with the spindle shaft, the reset component being provided between the puller and the spindle shaft, the bottom of the pull rod being threaded to the top of the tool holder.

8. A motorized tool changer spindle according to claim 7, wherein
a gap exists between the outer periphery of the pull rod and the inner periphery of the spindle shaft.
